(19) United States
(12) Patent Application Publication
(10) Pub. No.: US 2026/0175551 A1
(43) Pub. Date: Jun. 25, 2026

(54) DYE BLOCKING LAMINATES AND METHODS OF MAKING THE SAME

(71) Applicant: Bemis Associates, Inc., Shirley, MA (US)

(72) Inventors: Amir K. Nankali, Weston, MA (US); Aric Cormier, Gardner, MA (US); Martin Bidleman, Lunenburg, MA (US)

(21) Appl. No.: 19/425,420

(22) Filed: Dec. 18, 2025

Related U.S. Application Data
(60) Provisional application No. 63/736,920, filed on Dec. 20, 2024.

(51) Int. Cl. B32B 27/40; B32B 27/08; B32B 27/36; B32B 37/12; B32B 37/18; B32B 37/26

(52) U.S. Cl. CPC B32B 27/40; B32B 27/08; B32B 27/365; B32B 37/12; B32B 37/182; B32B 37/26; B32B 2037/268; B32B 2250/02; B32B 2274/00; B32B 2307/4026; B32B 2367/00; B32B 2369/00; B32B 2375/00; B32B 2437/00

(57) ABSTRACT

Disclosed herein are improved multi-layer laminates for decals or embellishments for clothing, e.g., lettering for athletic wear, and methods of producing the same.

### RELATED APPLICATIONS

This application claims the benefit of U.S. Provisional Application No. 63/736,920, filed Dec. 20, 2024, the teachings of which are incorporated herein by reference.

### BACKGROUND

The lettering applied to athletic wear shirts and jerseys can be applied by various means, including screen printing and hot melt “vinyl” decals, also known as “Heat Transfer Vinyl”. The generic term “vinyl” covers any class of polymer film including, but not limited to, PVC, EVA, and polyurethane. A well-established problem with embellishments or appliqués is that the dyes used to color the garment's fabric may be sublimation dyes, which are present on the surface of the fabric and can migrate into bonded lettering, discoloring the embellishment.

Historically, the discoloration of the embellishment has been addressed by adding one or more layers of a material known to block or hinder the chemical diffusion (e.g., migration) of the dyes. These layers are typically composed of silicones, such as poly dimethyl siloxane and its derivatives, activated carbon, or PVC. These layers may be combined with metal vapor deposition layers. These materials are often applied in a process that uses hazardous solvents. Moreover, the regular washing and disposal of these materials can result in the loss of hazardous materials into the environment.

Thus, there remains a need for embellishments that do not become discolored by dye migration and are recyclable.

### SUMMARY

The products described herein exhibit improved dye blocking, e.g., the products can fully block sublimated textile dyes. In addition, the products can be incorporated into a mono-material, all-polyester garment to enhance sustainability.

Disclosed herein are laminates (e.g., multi-layer laminates). The laminates may comprise an adhesive layer and a dye blocking layer. In some embodiments, the laminate comprises polyester. Also disclosed herein are methods of manufacturing a laminate (e.g., a multi-layer laminate).

In some embodiments, the adhesive layer may comprise a polyester adhesive material, e.g., a hot melt polyester adhesive. In some aspects, the adhesive layer comprises a thermoplastic polyurethane (TPU). In one aspect, the adhesive layer comprises a low or medium melt TPU. In some embodiments, the adhesive layer comprises a pigment, such as a color pigment or a white pigment. In some embodiments, the adhesive layer comprises a material having a gauge of 2-4 mil (e.g., a material having a gauge of 2 mil). In some embodiments, the adhesive layer comprises a polyurethane film.

A dye blocking layer may have a gauge of about 0.5-1.5 mil, e.g., a dye blocking layer may have a thickness able to inhibit all color change in a heat transfer embellishment under the conditions of a completed article being subject to 70° C. for about 48 hours (e.g., the color scale does not shift by more than 10%). In some embodiments, the dye blocking layer comprises a polyurethane or polycarbonate material. In some embodiments, the dye blocking layer comprises a polyethylene terephthalate (PET) material. The PET material is a recycled PET (rPET) or a natural PET material.

In some embodiments, the dye blocking layer comprises a blend of two or more materials. For example, a dye blocking layer may comprise a blend of a PET and a polymer. Alternatively, a dye blocking layer may comprise a blend of a PET and a second material selected from the group consisting of polybutylene terephthalate (PBT), polyethylene naphthalate (PEN), and an acrylic modifier. In another aspect, a dye blocking layer comprises a blend of a PET and a second material having a low Tg polyester-polyether material. In still another aspect, a dye blocking layer comprises a blend of a PET and a thermoplastic polyurethane. In some embodiments, a dye blocking layer comprises a blend having a total Tg greater than 50 C.

In some embodiments, the dye blocking layer comprises a rPET material having a gauge of 0.5-1.5 mil. In some embodiments, the dye blocking layer comprises a rPET material having a gauge of 1 mil. In some embodiments, the dye blocking layer comprises a white pigment.

In some embodiments, the dye blocking layer comprises a copolyester resin. A copolyester resin may include a high melt point copolyester, e.g., having a softening point greater than 150° C.

In some embodiments, a laminate further comprises a second adhesive layer and a top layer. The second adhesive layer may comprise a thermoplastic polyurethane (TPU). In some embodiments, the top layer comprises a barrier grade polymer. In some embodiments, the top layer comprises a pigment. In some embodiments, the top layer comprises two layers (e.g., the top layer comprises a top most top layer having a light color pigment and a bottom most top layer having a white pigment). In some embodiments, the top layer comprises a fabric.

In some embodiments, the one or more layers of the laminate are extruded (e.g., is hot melt extruded). In some embodiments, the one or more layers of the laminate are laminated together.

In some embodiments, the methods of manufacturing the laminate comprise depositing an adhesive layer, optionally on a release liner; and depositing a dye blocking layer on the adhesive layer. In some aspects, the adhesive layer and the dye blocking layer are laminated.

In some embodiments, the methods further comprise depositing a second adhesive layer on the dye blocking layer. In further embodiments, the methods further comprise a top layer deposited on the second adhesive layer. In some aspects, the second adhesive layer and the top layer are laminated with the adhesive layer and the dye blocking layer.

In alternative embodiments, the methods of manufacturing the laminate comprise co-extruding an adhesive layer and a dye blocking layer, optionally onto a release liner. In some embodiments, the co-extruded adhesive layer and dye blocking layer are laminated. In other embodiments, an adhesive layer, a dye blocking layer, a second adhesive layer, and a top layer are co-extruded, optionally onto a release liner.

In some aspects, the laminate is cut into one or more shapes (e.g., letters or symbols) or embellishments. The laminate may be cut using dye cutting or laser cutting. In some embodiments, the shapes or embellishments are affixed or bonded to a fabric. The shapes or embellishments may be bonded to the fabric in a single bonding step, e.g., utilizing a heat press or oven.

Disclosed herein are laminates comprising a first (upper) adhesive layer comprising a TPU (e.g., a low or medium melt TPU); a dye blocking layer comprising a copolyester resin; and a second (lower) adhesive layer comprising a TPU (e.g., a low or medium melt TPU). Also disclosed herein are laminates comprising a first (upper) adhesive layer comprising a polyester; a dye blocking layer comprising a rPET; and a second (lower) adhesive layer comprising a polyester.

### BRIEF DESCRIPTION OF THE FIGURES

The patent or application file contains at least one drawing executed in color. Copies of this patent or patent application publication with color drawings will be provided by the Office upon request and payment of the necessary fee.

Characteristics of the present invention will be more fully understood by reference to the following detailed description in conjunction with the attached drawings, in which:

FIG. 1 is a diagrammatic illustration showing a design of one embodiment of a laminate of the present invention.

FIG. 2 is a diagrammatic illustration showing a design of one embodiment of a laminate of the present invention.

FIG. 3 is a diagrammatic illustration showing a design of one embodiment of a laminate of the present invention.

FIG. 4 is a diagrammatic illustration showing a design of one embodiment of a laminate of the present invention.

FIGS. 5A-5B provide examples of garments having multi-layer laminates adhered to the garments.

FIG. 6 provides test results using blends with rPET.

FIG. 7 shows results of test samples bonded on a high migration fabric and placed in an oven at 70 C for 6 days. Sublimated dye migration was graded by visual observation.

FIGS. 8A-8B are flowcharts for alternative methods of forming and using a laminate of the present invention.

### DETAILED DESCRIPTION

Disclosed herein are laminates, e.g., multi-layer laminates, for use as decals. The disclosed laminates may be polyester, multi-layer laminates for decals or embellishments which can fully block sublimated textile dyes. In some aspects, the embellishments can be part of a mono-material all-polyester garment for sustainability.

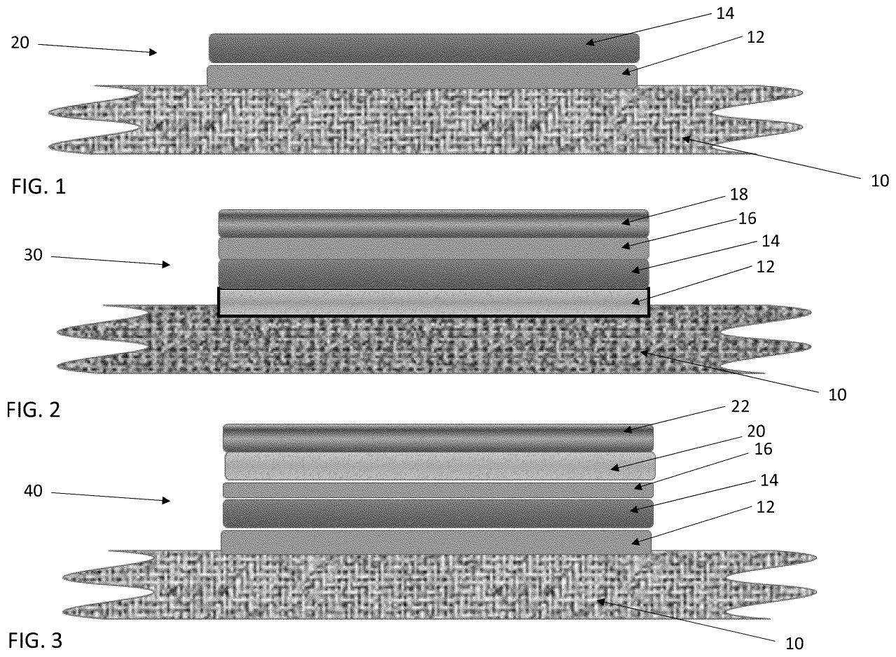

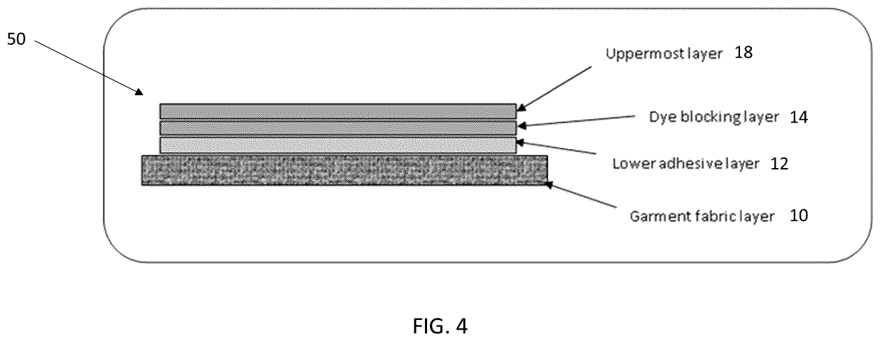

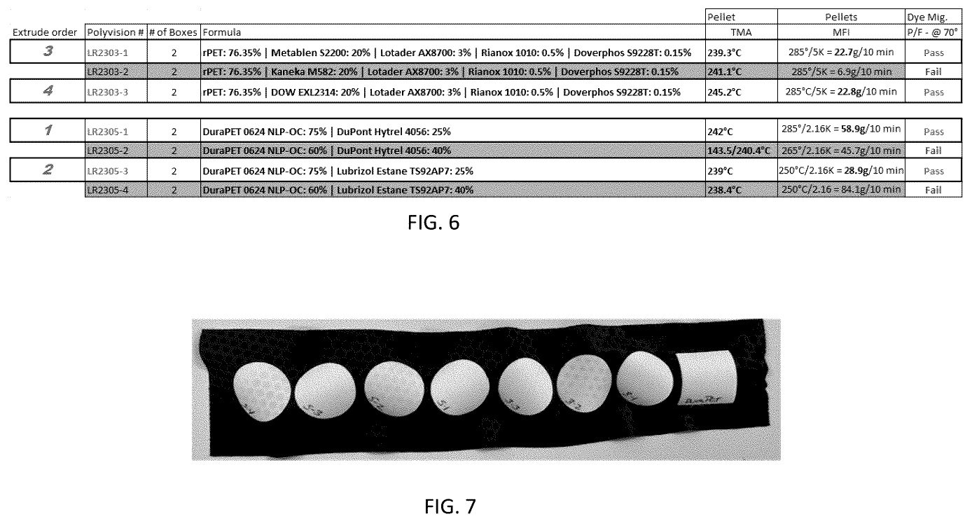

FIGS. 1 through 8B, wherein like parts are designated by like reference numerals throughout, illustrate an example embodiment or embodiments of laminates and methods for forming, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

Aspects of the invention are directed to laminates, e.g., laminates for forming decals. In some embodiments, the laminate disclosed herein comprises an adhesive layer and a dye blocking layer (i.e., is a two-layer laminate). In such instances, a dye blocking layer also forms a color layer, and an adhesive layer exhibits appropriate bond strength to both a fabric or substrate and the dye blocking layer. In some aspects, the laminate further includes a second adhesive layer and a top layer (i.e., is a four-layer laminate). A laminate comprising a separate top layer may have a top layer that is embossed with a surface roughness, e.g., to provide a soft feel, to provide a matte look, and/or to inhibit blocking of the laminate to itself (i.e., block the laminate from folding and sticking to itself during a wash cycle).

In some embodiments, the adhesive layer binds to a fabric layer and/or maintains adhesion to a dye blocking layer, e.g., the adhesive layer acts as an anchor layer between a garment and the dye blocking layer. In some aspects, the adhesive layer comprises an adhesive selected from thermoplastic polyurethane (TPU) and polyester (e.g., a copolyester). In some embodiments, the copolyester contains ethylene glycol, terephthalic acid, and one or more other monomers, such as isophthalic acid, adipic acid, and/or cyclohexanedicarboxylic acid (CHDA) & Cyclohexanedimethanol (CHDM). The adhesive may also contain polyethers, such as PEG or polyTHF, polyesters containing polycarbonate, polyamides and/or polyolefins. In some aspects, the adhesive may be a thermoset or thermoplastic adhesive. In some embodiments, the adhesive layer comprises a low or medium melt TPU adhesive. A low melt TPU may be a material that softens at a low temperature, e.g., below 100° C. and/or may be a material that is engineered to activate and/or bond at lower temperatures, e.g., 80°-120° C. A medium melt TPU may be a material that softens or melts at a medium temperature, e.g., between 110°-150° C. Non-limiting examples of a TPU include AH-535 or AH-560 from BASF Elastollan Hotbond; NeoRez R-600, NeoRez R-9621, NeoRez R-9630, and NeoRez R-9430 from DSM; the Dispercoll range from Covestro, including Dispercoll U56, Dispercoll U54, and Dispercoll U2682; and Sancure 20025F from Lubrizol

In some embodiments, the adhesive layer further comprises a crosslinker. In some embodiments, a crosslinker may be a multifunctional isocyanate crosslinker, such as water dispersible multifunctional isocyanates, encapsulated multifunctional isocyanates, and/or chemically blocked multifunctional isocyanates. Water dispersible multifunctional isocyanate crosslinkers may contain a surfactant group that is typically non-ionic to allow them to disperse into water. Non-limiting examples of chemically blocked multifunctional isocyanate crosslinkers may include those provided by Covestro. In one embodiment, an exemplary crosslinker may be a urethane crosslinker. Other examples of crosslinkers that may be utilized in the adhesive layer include UV cure, epoxy-silicone, carbodiimide silicone, and/or propylene imine crosslinkers. A crosslinker may be added to the adhesive layer to provide improved wear resistance. In some aspects, the adhesive layer further comprises a pigment (e.g., a white pigment).

Optionally, the laminate comprises a second adhesive layer. The second adhesive layer may be on the opposing side of the dye blocking layer from the adhesive layer that binds to a fabric layer, e.g., the second adhesive layer may be on the top side of a dye blocking layer. The second adhesive layer may adhere the dye blocking layer to a top layer.

In some embodiments, the first adhesive layer and the second adhesive layer are the same material. In other embodiments, the first adhesive layer and the second adhesive layer are different materials. In some embodiments, the first adhesive layer and the second adhesive layer each comprise a TPU adhesive. In some embodiments, the first adhesive layer comprises a TPU adhesive and the second adhesive layer comprises a polyester adhesive. In some embodiments, the first adhesive layer comprises a polyester adhesive and the second adhesive layer comprises a TPU adhesive. In some embodiments, the first adhesive layer and the second adhesive layer each comprise a polyester adhesive.

A dye blocking layer may block sublimated textile dyes, e.g., may bock or inhibit the chemical diffusion or migration of dyes. In some aspects, the dye blocking layer is formed from a construction plastic, such as polyethylene terephthalate (PET), polycarbonates (e.g., Lexan 8010), or polyurethanes based on polycarbonate polyols (e.g., Eternalast grades from UBE Corporation, Carbothane from Lubrizol, and Covestro Desmopan grades). Additional non-limiting examples of materials for forming a dye blocking layer include the Hostaphan grade films from Mitsubishi; Mylar & Melinex grade films from DuPont Teijin films; PET films from SKC, Inc. ; Lumirror PET films from Toray Plastics; and PET films from Xamax. In one embodiment, the dye blocking layer comprises PET, such as regular or virgin PET or recycled PET (rPET). In some embodiments, the dye blocking layer comprises a material that has a high glass transition temperature (Tg) (e.g., above room temperature, that is above 20-22° C.) and/or possibly exhibits a degree of crystallinity. For example, the dye blocking layer comprises one or more materials (e.g., PET) that combined have a Tg of between about 65° C. to 85° C.

In some embodiments, the dye blocking layer comprises a copolyester resin. A copolyester resin may be a modified polyester, e.g., combining different monomers (such as diacids/diols) to create a thermoplastic with enhanced properties. In some embodiments, the copolyester resin is an extrusion grade copolyester. In some embodiments, the copolyester resin is a copolyester having a TG value (glass transition temperature) above 50. In some embodiments, the copolyester resin comprises a high melt point copolyester, e.g., has a softening point greater than 150° C.

In some aspects, the dye blocking material comprises one or more additives. In some aspects, the one or more additives comprises a pigment to improve hiding or blocking. In some aspects, the one or more additives comprises a second material to improve the extrusion processing and/or to improve flexibility, and optionally add softness to the dye blocking layer. The one or more additives may include a pigment (e.g., white pigment), a structural polymer (e.g., polybutylene terephthalate (PBT), polyethylene naphthalate (PEN), thermoplastic (TPE) olefins, polycarbonates, and the like), an impact modifier (e.g., acrylic impact modifier), a processing aide and/or a material having a Tg below room temperature, for example a Tg of about 0° C. to a Tg of about −30° C. An acrylic impact modifier may reduce the brittleness and stiffness of the dye blocking material. An impact modifier may be a core-shell type emulsion in which polymer particles are made in the size range of about 200-400 nm which are multiple shells of alternating hard-soft polymer. The soft core material may be based on butyl acrylate or ethyl hexyl acrylate and the hard shell material may be MMA based. Non-limiting examples of an acrylic impact modifier include Metablen S2200, Mitsubishi, silicone-acrylic impact modifier; Lotader AX 8700, SK Functional polymer, acrylic modifier; Kane Ace M582, Kaneka, acrylic modifier; and Paraloid EXL 2314, Dow, acrylic modifier. The acrylic impact modifier may be included at about 1%-25% loading, or about 3%, 5%, 8%, 10%, 12%, 15%, 18% or 20% loading. For example, an impact modifier of Metablen S2200 may be added at about 20% loading; Lotader AX8700 may be added at about 3% loading; Kane Ace M582 may be added at about 20% loading; or Paraloid EXL 2314 may be added at about 20% loading. In some embodiments, a soft material (e.g., a material having a Tg below room temperature) is a softer, low Tg polyester-polyether material or a TPU, such as, Hytrel 4056, Dupont or Lubrizol Estane TS92AP7. The softer material may be included at about 20-50% loading, or about 25%, 30%, 35% or 40% loading. For example, the material may be added at about 25% or 40% loading. In some aspects, an acrylic impact modifier optionally includes one or more antioxidants (such as Rianox 1010 and/or Doverphos S9228T). An antioxidant may be added at 0.1%-1%, or about 0.15%, 0.2%, 0.25%, 0.3%, 0.35%, 0.4%, 0.45%, or 0.5%. For example, Rianox 1010 may be added at about 0.5% and/or Doverphos S9228T may be added at about 0.15%. Optionally, the one or more additives are compounded with the primary dye blocking material. The dye blocking layer may optionally comprise a pigment, such as a white pigment. In one embodiment, the dye blocking layer comprises rPET and a white pigment, optionally with one or more additional additives. In some embodiments, a laminate layer comprises from about 5-20% by weight of pigment. The amount of pigment added to a layer of the laminate may be dependent on one or more factors, such as particle size of the pigment.

In some aspects, a dye blocking layer comprises a mixture of two or more components. For example, the dye blocking layer may include a polymer with a Tg greater than 50° C. and a second, softer material. A polymer having a Tg greater than 50° C. may result in a laminate being stiff and inelastic; thus, the polymer may be blended with a softer material, such as a TPE olefin. However, if too much softer material is added to the polymer the dye blocking performance of the laminate is compromised. In some embodiments, the majority material of the dye blocking layer is a polymer, such as PET (e.g., rPET). In one embodiment, the laminate comprises at least 65% or 65-70% of polymer, e.g., rPET. In some embodiments, the dye blocking layer comprises a blend of the polymer and the softer material. It is generally understood that the polymer and a secondary material may not be fully blended at the molecular level which may result in regions or domains of the secondary material (e.g., the softer material) dispersed in the polymer (e.g., a high Tg polymer). The blend of materials may have a combined Tg value of greater than 45° C. or greater than 50° C. The Tg value of the blend of materials may be a calculated average Tg based on the weight fractions of each material in the blend and their respective Tgs (as compared to a measured Tg value of the blend). The calculated Tg value of the blend (e.g., Tg12) may be calculated using the Fox equation. The Flory-Fox equation serves the purpose of providing a model for how glass transition temperature changes over a given composition range (in weight fraction). The Fox equation is as follows:

$$Tg 12 = w 1 Tg 1 + w 2 Tg 2$$

where w1 and w2 are weight fractions of components 1 and 2, respectively. Using the Fox equation, a calculated Tg for a blend of materials forming the dye blocking layer may be greater than 50° C.

In one aspect, the dye blocking layer comprises about 50% PET or more (e.g., about 50%, 55%, 60%, 70%, 75%, or 80% PET) and about 30% of a soft material or less (e.g., about 30%, 25%, 20%, 15% of a soft material), such as an impact modifier or TPE rubber, and optionally further comprising a white pigment. In one aspect, the dye blocking layer has a total Tg of about 50 C-70 C (e.g., about 50 C, 55 C, 60 C, 65 C or 70 C). In another aspect, the dye blocking layer comprises about 65-70% PET and about 30% or less of an additional material, such as a material that is softer than the PET.

In some embodiments, a dye blocking layer comprises a mixture of two or more components. For example, the dye blocking layer may include a copolyester resin and a second material. In some embodiments, the majority material of the dye blocking layer is a copolyester resin. In one embodiment, the laminate comprises at least 65% or 65-70% of copolyester resin. In some embodiments, the dye blocking layer comprises a blend of the copolyester resin and the secondary material.

The optional top layer may act as an appearance color layer or barrier layer. In some embodiments, the top layer comprises a polymeric material (e.g., a high melting material with good mechanical properties) or a fabric material (e.g., a fabric twill). In one embodiment, the top layer comprises a polymeric material (e.g., a high melt polymer). A continuous polymer layer may be a barrier layer, e.g., is able to withstand the heat required to bond the laminate to a fabric. Non-limiting examples of a polymeric material for forming a top layer include a TPU (e.g., a PUD such as Covestro Impranil DL1554), a polyester-polyether (e.g., Hytrel grades). In one embodiment, the top layer comprises a fabric twill. Non-limiting examples of a fabric include a polyester or a nylon layer. In some embodiments, the top layer comprises a pigment (e.g., a colored pigment). In other embodiments, the top layer comprises two layers, such as in situations where the top layer is lightly colored. For example, a first layer may be a light color, such as yellow or a pastel, and a second layer may be white. The white layer under the color layer assists in providing opacity and hiding the under layers. A laminate comprising a separate top layer may have a top layer that is embossed with a surface roughness, e.g., to provide a soft feel, to provide a matte look, and/or to inhibit blocking of the laminate to itself (i.e., block the laminate from folding and sticking to itself during a wash cycle).

A laminate may comprise an adhesive layer, a dye blocking layer, a second adhesive layer, and a top layer. A second adhesive layer and/or dye blocking may be pigmented white. Alternatively, the second adhesive layer may be pigmented with the final color of choice for the laminate (e.g., red, blue, yellow, etc.). In addition, a top layer may additionally be pigmented to have the same color as the second adhesive layer when it is pigmented with a color.

In one embodiment, a first adhesive layer comprises a TPU, a dye blocking layer comprises rPET, and an optional second adhesive layer comprises a TPU. In one embodiment, a first adhesive layer comprises a TPU, a dye blocking layer comprises a copolyester resin, and an optional second adhesive layer comprises a TPU. In one embodiment, a first adhesive layer comprises a polyester, a dye blocking layer comprises rPET, and an optional second adhesive layer comprises a polyester. In one embodiment, a first adhesive layer comprises a polyester, a dye blocking layer comprises a copolyester resin, and an optional second adhesive layer comprises a polyester. In one embodiment, a first adhesive layer comprises a TPU, a dye blocking layer comprises rPET, and a second adhesive layer comprises a polyester. In one embodiment, a first adhesive layer comprises a TPU, a dye blocking layer comprises a copolyester resin, and a second adhesive layer comprises a polyester. In one embodiment, a first adhesive layer comprises a polyester, a dye blocking layer comprises rPET, and an optional second adhesive layer comprises a TPU. In one embodiment, a first adhesive layer comprises a polyester, a dye blocking layer comprises a copolyester resin, and an optional second adhesive layer comprises a TPU.

In some embodiments, one or more layers of the laminate has a thickness of about 0.1 to 5.0 mil. In some embodiments, one or more layers of the laminate has a thickness of 0.1 to 2.0 mil, 0.5 to 1.5 mil, or 2 to 4 mil. In some embodiments, a layer of the laminate has a thickness of about 0.1 to 1.5 mil, 0.25 to 1.5 mil, 0.5 to 1.5 mil, 0.75 to 1.5 mil, 1.0 to 1.5 mil, 1.25 to 1.5 mil, 0.1 to 1.25 mil, 0.25 to 1.25 mil, 0.5 to 1.25 mil, 0.75 to 1.25 mil, 1.0 to 1.25 mil, 0.1 to 1.0 mil, 0.25 to 1.0 mil, 0.5 to 1.0 mil, 0.75 to 1.0 mil, 0.1 to 0.75 mil, 0.25 to 0.75 mil, or 0.5 to 0.75 mil. In one embodiment, a layer of the laminate has a thickness of about 1.0 mil or less than 1.0 mil. In some embodiments, a dye blocking layer has a thickness of about 0.5 to 1.5 mil, about 1.0 mil, or less than 1.0 mil.

In some embodiments, a layer of the laminate has a thickness of about 1.0 to 5.0 mil, 2.0 to 4.0 mil or 2.5 to 3.5 mil. In some embodiments, a layer of the laminate has a thickness of about 1.5 to 4.5 mil, 1.75 to 4.5 mil, 2.0 to 4.5 mil, 2.25 to 4.5 mil, 2.5 to 4.5 mil, 2.75 to 4.5 mil, 3.0 to 4.5 mil, 3.25 to 4.5 mil, 3.5 to 4.5 mil, 3.75 to 4.5 mil, 4.0 to 4.5 mil, 4.25 to 4.5 mil, 1.5 to 4.25 mil, 1.75 to 4.25 mil, 2.0 to 4.25 mil, 2.25 to 4.25 mil, 2.5 to 4.25 mil, 2.75 to 4.25 mil, 3.0 to 4.25 mil, 3.25 to 4.25 mil, 3.5 to 4.25 mil, 3.75 to 4.25 mil, 4.0 to 4.25 mil, 1.5 to 4.0 mil, 1.75 to 4.0 mil, 2.0 to 4.0 mil, 2.25 to 4.0 mil, 2.5 to 4.0 mil, 2.75 to 4.0 mil, 3.0 to 4.0 mil, 3.25 to 4.0 mil, 3.5 to 4.0 mil, 3.75 to 4.0 mil, 1.5 to 3.75 mil, 1.75 to 3.75 mil, 2.0 to 3.75 mil, 2.25 to 3.75 mil, 2.5 to 3.75 mil, 2.75 to 3.75 mil, 3.0 to 3.75 mil, 3.25 to 3.75 mil, 3.5 to 3.75 mil, 1.5 to 3.5 mil, 1.75 to 3.5 mil, 2.0 to 3.5 mil, 2.25 to 3.5 mil, 2.5 to 3.5 mil, 2.75 to 3.5 mil, 3.0 to 3.5 mil, 3.25 to 3.5 mil, 1.5 to 3.25 mil, 1.75 to 3.25 mil, 2.0 to 3.25 mil, 2.25 to 3.25 mil, 2.5 to 3.25 mil, 2.75 to 3.25 mil, 3.0 to 3.25 mil, 1.5 to 3.0 mil, 1.75 to 3.0 mil, 2.0 to 3.0 mil, 2.25 to 3.0 mil, 2.5 to 3.0 mil, 2.75 to 3.0 mil, 1.5 to 2.75 mil, 1.75 to 2.75 mil, 2.0 to 2.75 mil, 2.25 to 2.75 mil, 2.5 to 2.75 mil, 1.5 to 2.5 mil, 1.75 to 2.5 mil, 2.0 to 2.5 mil, 2.25 to 2.5 mil, 1.5 to 2.25 mil, 1.75 to 2.25 mil, 2.0 to 2.25 mil, 1.5 to 2.0 mil, 1.75 to 2.0 mil, or 1.5 to 1.75 mil. In one embodiment, a layer of the laminate has a thickness of about 2.0 mil. In some embodiments, an adhesive layer and/or top layer has a thickness of about 2.0 to 4.0 mil or about 2.0 mil.

In some embodiments, a laminate has a thickness of about 2.0 to 10.0 mil, 2.5 to 9.5 mil, or 2.5 to 5.5 mil. In some embodiments, a laminate has a thickness of about 2.5 to 9.5 mil, 3 to 9.5 mil, 3.5 to 9.5 mil, 4.0 to 9.5 mil, 4.5 to 9.5 mil, 5.0 to 9.5 mil, 5.5 to 9.5 mil, 6.0 to 9.5 mil, 6.5 to 9.5 mil, 7.0 to 9.5 mil, 7.5 to 9.5 mil, 8.0 to 9.5 mil, 8.5 to 9.5 mil, 9.0 to 9.5 mil, 2.5 to 9.0 mil, 3.0 to 9.0 mil, 3.5 to 9.0 mil, 4.0 to 9.0 mil, 4.5 to 9.0 mil, 5.0 to 9.0 mil, 5.5 to 9.0 mil, 6.0 to 9.0 mil, 6.5 to 9.0 mil, 7.0 to 9.0 mil, 7.5 to 9.0 mil, 8.0 to 9.0 mil, 8.5 to 9.0 mil, 2.5 to 8.5 mil, 3.0 to 8.5 mil, 3.5 to 8.5 mil, 4.0 to 8.5 mil, 4.5 to 8.5 mil, 5.0 to 8.5 mil, 5.5 to 8.5 mil, 6.0 to 8.5 mil, 6.5 to 8.5 mil, 7.0 to 8.5 mil, 7.5 to 8.5 mil, 8.0 to 8.5 mil, 2.5 to 8.0 mil, 3.0 to 8.0 mil, 3.5 to 8.0 mil, 4.0 to 8.0 mil, 4.5 to 8.0 mil, 5.0 to 8.0 mil, 5.5 to 8.0 mil, 6.0 to 8.0 mil, 6.5 to 8.0 mil, 7.0 to 8.0 mil, 7.5 to 8.0 mil, 2.5 to 7.5 mil, 3.0 to 7.5 mil, 3.5 to 7.5 mil, 4.0 to 7.5 mil, 4.5 to 7.5 mil, 5.0 to 7.5 mil, 5.5 to 7.5 mil, 6.0 to 7.5 mil, 6.5 to 7.5 mil, 7.0 to 7.5 mil, 2.5 to 7.0 mil, 3.0 to 7.0 mil, 3.5 to 7.0 mil, 4.0 to 7.0 mil, 4.5 to 7.0 mil, 5.0 to 7.0 mil, 5.5 to 7.0 mil, 6.0 to 7.0 mil, 6.5 to 7.0 mil, 2.5 to 6.5 mil, 3.0 to 6.5 mil, 3.5 to 6.5 mil, 4.0 to 6.5 mil, 4.5 to 6.5 mil, 5.0 to 6.5 mil, 5.5 to 6.5 mil, 6.0 to 6.5 mil, 2.5 to 6.0 mil, 3.0 to 6.0 mil, 3.5 to 6.0 mil, 4.0 to 6.0 mil, 4.5 to 6.0 mil, 5.0 to 6.0 mil, 5.5 to 6.0 mil, 2.5 to 5.5 mil, 3.0 to 5.5 mil, 3.5 to 5.5 mil, 4.0 to 5.5 mil, 4.5 to 5.5 mil, 5.0 to 5.5 mil, 2.5 to 5.0 mil, 3.0 to 5.0 mil, 3.5 to 5.0 mil, 4.0 to 5.0 mil, 4.5 to 5.0 mil, 2.5 to 4.5 mil, 3.0 to 4.5 mil, 3.5 to 4.5 mil, 4.0 to 4.5 mil, 2.5 to 4.0 mil, 3.0 to 4.0 mil, 3.5 to 4.0 mil, 2.5 to 3.5 mil, 3.0 to 3.5 mil, or 2.5 to 3.0 mil. In one embodiment, a laminate has a thickness of about 3 mil, 4 mil, or 5 mil.

The laminate disclosed herein exhibits softness and elasticity. Elasticity may be assessed using an extension test on an Instron machine. In some embodiments, the laminate (e.g., a laminate having 3-layers, such as a copolyester—rPET-copolyester film) exhibits a load, e.g., under strain, of about 8.0 to 11.0 lb/f, e.g., for a laminate having a thickness of about 4 to 6 mil.

In some embodiments, the laminate is cut into one or more shapes, e.g., letters. The laminate may be cut using dye cutting and/or laser cutting. The laminate shapes may form decals, appliques, and/or embellishments to be affixed to a fabric. The individual shapes may be affixed to a garment, e.g., using heat laminate. In some embodiments, the garment is athletic wear. In some embodiments, the laminate is affixed or bonded to a fabric. Non-limiting examples of the type of fabric include cotton (e.g., cotton-Spandex), polyester (e.g., polyester-Spandex), and nylon (e.g., nylon-Spandex). In some embodiments, the laminate is bonded to a two or three-layer fabric, such as a fabric comprising a waterproof membrane. In some aspects, a laminate comprising a thicker second or adhesive layer is required for durability on a thicker fabric. It is generally understood that some fabric, such as rip-stop nylon or a three-layer fabric, are more difficult to bond to, and so a laminate will be selected based on the adhesion properties of the second layer.

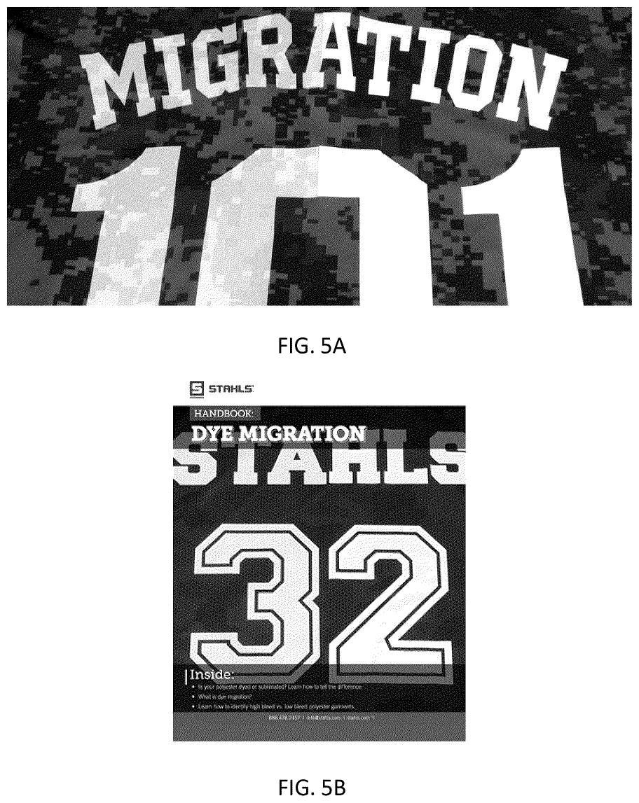

As shown in FIG. 1, a laminate may be a two-layer laminate 20. In some aspects, a two-layer laminate 20 comprises first layer (adhesive layer) 12 and second layer (dye blocking layer) 14. As shown in FIG. 2, a laminate may be a four-layer laminate 30. In some aspects, a four-layer laminate 30 comprises first layer (adhesive layer) 12, second layer (dye blocking layer) 14, third layer (second adhesive layer) 16, and fourth layer (top layer) 18. As shown in FIG. 3, a laminate may be a five-layer laminate 40. In some aspects, a five-layer laminate 40 comprises first layer (adhesive layer) 12, second layer (dye blocking layer) 14, third layer (second adhesive layer) 16, fourth layer (bottom half of 2-part top layer) 20, and fifth layer (top half of 2-part top layer) 22. In some aspects, a laminate is applied to a fabric layer 10. In some aspects, a laminate is produced on a release liner, e.g., a textured PET liner. The laminate may be removed from the release liner. The laminate may be cut into individual shapes that may then be applied to a fabric (see FIGS. 5A-5B).

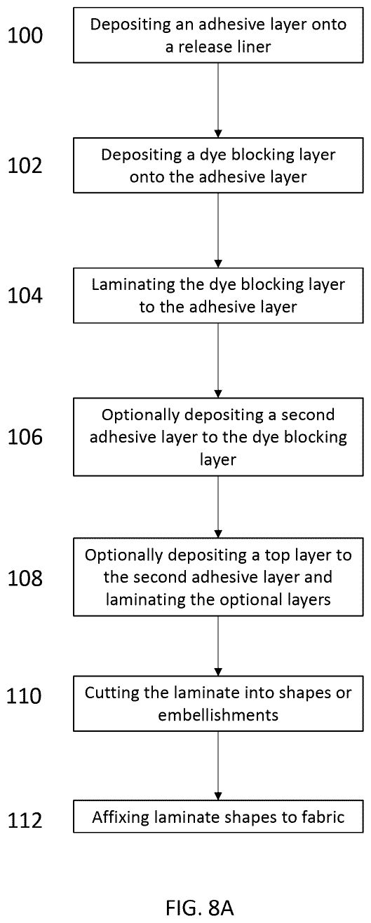

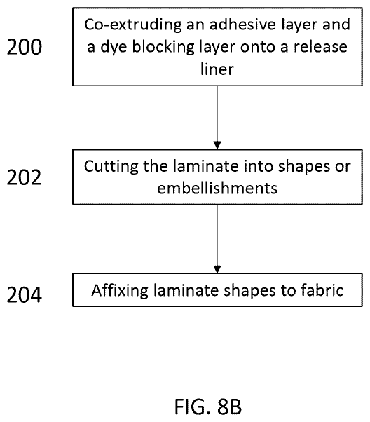

As outlined in FIG. 8A, a method of forming and using a laminate may comprise the steps of: depositing an adhesive layer on a release liner 100; depositing a dye blocking layer on the adhesive layer 102; laminating the adhesive layer and the dye blocking layer 104; cutting the laminate into shapes or embellishments 110; and affixing the laminate shapes to a fabric 112. Optionally, a second adhesive layer is deposited on the dye blocking layer 106, and a top layer is deposited on the second adhesive layer, and the layers are laminated 108. Alternatively, as outlined in FIG. 8B, an adhesive layer and dye blocking layer are co-extruded onto a release liner to form a laminate 200; cutting the laminate into shapes or embellishments 202; and affixing the laminate shapes to a fabric 204. Optionally, an adhesive layer, dye blocking layer, a second adhesive layer, and a top layer are co-extruded onto a release liner.

In some embodiments, the formed laminate is cut into shapes, such as letters or symbols, using dye cutting or laser cutting 110 or 202. The laminate shapes may then be affixed or bonded to a fabric 112 or 204. In one embodiment, the laminate shapes or embellishments are bonded to the fabric in a single bonding step, e.g., utilizing a heat press or oven. For example, a laminate shape or embellishment may be bonded to a fabric by utilizing a heat press at a temperature of about 135-165° C., 135-160° C., 135-155° C., 135-150° C., 135-145° C., 140-165° C., 140-160° C., 140-155° C, 140-150° C., 145-165° C., 145-160° C., 145-155° C., 150-165° C., or 150-160° C. for a period of time of about 20 seconds to 1 minute, 30 seconds to 1 minute, 40 seconds to 1 minute, 50 seconds to 1 minute, 20 to 50 seconds, 30 to 50 seconds, 40 to 50 seconds, 20 to 40 seconds, 30 to 40 seconds, or 20 to 30 seconds. In one embodiment, the laminate is bonded to the fabric using a heat press at a temperature of 150° C. for about 1 minute. In one embodiment, the laminate is bonded to the fabric using a heat press at a temperature of 165° C. for a period of about 20 seconds.

In one embodiment, the laminate shapes or embellishments are bonded to the fabric in a two-step bonding process, e.g., utilizing a heat press or oven. The laminate embellishment may first be tack bonded to the fabric at a first temperature. The laminate may then be fully bonded to the fabric at a temperature greater than 135° C. In some embodiments, the laminate may be fully bonded to the fabric after one or more drying cycles at a temperature greater than 135° C. For example, the laminate may be fully bonded to a fabric by utilizing a heat press at a temperature of about 135-165° C. for a period of time of about 20 seconds to 1 minute. In some embodiments, the bonded fabric is rested for about 24 hours to allow the adhesive to harden/crystallize.

In some embodiments, the laminate is cut to predetermined dimensions, e.g., using dye cutting or laser cutting. In some embodiments, the laminate can be cut into individual shapes/letters to form decals or appliques. In some embodiments, the decals are laminated to a garment fabric, e.g., are heat laminated to the garment fabric. Upon applying the laminate to the fabric, the release liner is removed. Examples of the cut laminate, e.g., the decals, applied to a fabric are shown in FIGS. 5A-5B.

In some embodiments, a laminate comprises a first layer, which is an adhesive layer (e.g., an anchor layer), and a second layer, which is a dye blocking layer (e.g., a barrier layer). Optionally, the laminate further comprises a third layer, which is a second adhesive layer and a fourth layer, which is a top layer (e.g., an appearance color layer). In some embodiments, the first layer and/or third layer comprises a thermoplastic polyurethane (TPU) or polyester. In some embodiments, the second layer comprises a polyethylene terephthalate (PET) or a copolyester resin, optionally in combination with a second material. In some embodiments, the fourth layer comprises a barrier grade polymer. Alternatively, the fourth layer comprises a fabric.

One skilled in the art readily appreciates that the present invention is well adapted to carry out the objects and obtain the ends and advantages mentioned, as well as those inherent therein. The details of the description and the examples herein are representative of certain embodiments, are exemplary, and are not intended as limitations on the scope of the invention. Modifications therein and other uses will occur to those skilled in the art. These modifications are encompassed within the spirit of the invention. It will be readily apparent to a person skilled in the art that varying substitutions and modifications may be made to the invention disclosed herein without departing from the scope and spirit of the invention.

The articles “a” and “an” as used herein in the specification and in the claims, unless clearly indicated to the contrary, should be understood to include the plural referents. Claims or descriptions that include “or” between one or more members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides all variations, combinations, and permutations in which one or more limitations, elements, clauses, descriptive terms, etc., from one or more of the listed claims is introduced into another claim dependent on the same base claim (or, as relevant, any other claim) unless otherwise indicated or unless it would be evident to one of ordinary skill in the art that a contradiction or inconsistency would arise. It is contemplated that all embodiments described herein are applicable to all different aspects of the invention where appropriate. It is also contemplated that any of the embodiments or aspects can be freely combined with one or more other such embodiments or aspects whenever appropriate. Where elements are presented as lists, e.g., in Markush group or similar format, it is to be understood that each subgroup of the elements is also disclosed, and any element(s) can be removed from the group. It should be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in so many words herein. It should also be understood that any embodiment or aspect of the invention can be explicitly excluded from the claims, regardless of whether the specific exclusion is recited in the specification. For example, any one or more active agents, additives, ingredients, optional agents, types of organism, disorders, subjects, or combinations thereof, can be excluded.

Where ranges are given herein, the invention includes embodiments in which the endpoints are included, embodiments in which both endpoints are excluded, and embodiments in which one endpoint is included and the other is excluded. It should be assumed that both endpoints are included unless indicated otherwise. Furthermore, it is to be understood that unless otherwise indicated or otherwise evident from the context and understanding of one of ordinary skill in the art, values that are expressed as ranges can assume any specific value or subrange within the stated ranges in different embodiments of the invention, to the tenth of the unit of the lower limit of the range, unless the context clearly dictates otherwise. It is also understood that where a series of numerical values is stated herein, the invention includes embodiments that relate analogously to any intervening value or range defined by any two values in the series, and that the lowest value may be taken as a minimum and the greatest value may be taken as a maximum. Numerical values, as used herein, include values expressed as percentages. For any embodiment of the invention in which a numerical value is prefaced by “about” or “approximately”, the invention includes an embodiment in which the exact value is recited. For any embodiment of the invention in which a numerical value is not prefaced by “about” or “approximately”, the invention includes an embodiment in which the value is prefaced by “about” or “approximately”.

“Approximately” or “about” generally includes numbers that fall within a range of 1% or in some embodiments within a range of 5% of a number or in some embodiments within a range of 10% of a number in either direction (greater than or less than the number) unless otherwise stated or otherwise evident from the context (except where such number would impermissibly exceed 100% of a possible value). It should be understood that, unless clearly indicated to the contrary, in any methods claimed herein that include more than one act, the order of the acts of the method is not necessarily limited to the order in which the acts of the method are recited, but the invention includes embodiments in which the order is so limited. It should also be understood that unless otherwise indicated or evident from the context, any product or composition described herein may be considered “isolated”.

As used herein the term “comprising” or “comprises” is used in reference to compositions, methods, and respective component(s) thereof, that are essential to the invention, yet open to the inclusion of unspecified elements, whether essential or not.

As used herein the term “consisting essentially of” refers to those elements required for a given embodiment. The term permits the presence of additional elements that do not materially affect the basic and novel or functional characteristic(s) of that embodiment of the invention.

The term “consisting of” refers to compositions, methods, and respective components thereof as described herein, which are exclusive of any element not recited in that description of the embodiment.

It is to be understood that the inventions disclosed herein are not limited in their application to the details set forth in the description or as exemplified. The invention encompasses other embodiments and is capable of being practiced or carried out in various ways. Also, it is to be understood that the phraseology and terminology employed herein is for the purpose of description and should not be regarded as limiting.

While certain compositions and methods of the present invention have been described with specificity in accordance with certain embodiments, the following examples serve only to illustrate the methods and compositions of the invention and are not intended to limit the same.

### EXEMPLIFICATION

### Example 1: Four Layer Laminate Embodiment

An exemplary dye blocking laminate may comprise four distinct layers as follows:
1. (Anchor adhesive): Gauge is about 2 mil (range of 1.0-3.0mil), this material is a copolyester resin supplied by Griltex, D1750 EG. Added to this at a 20% loading is a white masterbatch supplied by Ampercet, grade 7100281-n.
2. (Dye blocking layer): Gauge is about 1 mil, extruded from rPET supplied by Polyvisions. The layer further includes Ampercet 7100281-n white masterbatch at 10% loading.
3. (Top layer): Same as the anchor adhesive layer: Gauge is about 2 mil (range 1.0-3.0mil), this material is a copolyester resin supplied by Griltex, D1750 EG. Added to this at a 20% loading is a white masterbatch supplied by Ampercet, grade 7100281-n.
4. (Fabric twill): poly TWILL polyester twill fabric supplied by Stahls.

Alternative dye blocking layers are described in Example 2.

### Example 2: Alternative Dye Blocking Layers

Exemplary embodiments of the dye blocking layer for a dye blocking laminate include the following:
1. 75:25% blend of Durapet 0624NLP-0C from Polyvisions: Hytrel 4056
2. 75:25 blend of Durapet 0624NLP-0C from Polyvisions: Estane TS92AP 7
3. 76.35:20.0:3.0:0.5:0.15 blend of Durapet 0624NLP-0C from Polyvisions: Metablen S2200: Lotader AX 8700: Rianox 1010: Doverphos S9228T
4. 76.35:20.0:3.0:0.5:0.15 blend of Durapet 0624NLP-0C from Polyvisions: Kaneka M 582: Lotader AX 8700: Rianox 1010: Doverphos S9228T
5. 76.35:20.0:3.0:0.5:0.15 blend of Durapet 0624NLP-0C from Polyvisions: Dow EXL 2314: Lotader AX 8700: Rianox 1010: Doverphos S9228T

### Example 3: Alternative Four Layer Laminate Embodiment

An exemplary dye blocking laminate may comprise four distinct layers as follows:
1. (Anchor adhesive): Gauge is about 2 mil (range of 1.0-3.0mil), this material is a copolyester resin supplied by Griltex, D1750 EG. Added to this at a 20% loading is a white masterbatch supplied by Ampercet, grade 7100281-n.
2. (Dye blocking layer): Gauge is about 1 mil, extruded from rPET supplied by Polyvisions. The layer further includes Ampercet 7100281-n white masterbatch at 10% loading.
3. (Top layer): Same as the anchor adhesive layer: Gauge is about 2 mil (range 1.0-3.0mil), this material is a copolyester resin supplied by Griltex, D1750 EG. Added to this at a 20% loading is a white masterbatch supplied by Ampercet, grade 7100281-n.
4. (Water Based Polyurethane): Covestro DL1554 with white pigment at 25% loading (Colanyl white R530, supplied by Heubach).

Alternative dye blocking layers are described in Example 2.

### Example 5: Manufacture and Application of a Laminate

An exemplary laminate having three layers, a copolyester top layer, a copolyester bottom layer and a mid-layer of rPET is manufactured. The copolyester top layer and bottom layer may be identical. Each copolyester layer comprises 20% white masterbatch and the rPET layer comprises 10% white masterbatch. The laminate may be manufactured via an extrusion process using a commercial scale extruder.

The extrusion process may be an A-B-C process or an A-B-A process. An exemplary A-B-C extrusion process utilizes three independent extrusion barrels (single screw) set up so that A barrel (top layer) and C barrel (bottom layer) are fed with the copolyester and white masterbatch and run at 350F (+/−20 F) and the B barrel (middle layer) is fed with rPET (Durapet) and white masterbatch and run at 500 F (+/−20 F). The three barrels feed into a single “slot die” which creates a three-layer film of roughly 2-1-2 mil gauge. Alternatively, the extrusion process may be an A-B-A process where the copolyester material is extruded from a single barrel and splits at the die to provide the top and bottom layer. In addition, a fabric, e.g., a twill fabric, can be laminated onto the top layer to complete a 4-layer laminate.

Once a laminate is manufactured individual embellishments may be cut from the laminate and placed on a fabric in a desired position and then can be fully bonded in a flat press. Alternatively, an intermediate “tacking” step may be incorporated in the application process in which a liner for the laminate, e.g., textured PET, is removed and additional embellishments may be added. A full bond of the any and all embellishments may be completed in the press. The bonded sample may be left for 24 hours to allow the adhesive to harden/crystallize.

What is claimed is:

1. A laminate comprising:
a) an adhesive layer; and
b) a dye blocking layer.

2. The laminate of claim 1, wherein the laminate is polyester.

3. The laminate of claim 1, wherein the adhesive layer comprises a polyester adhesive material.

4. The laminate of claim 1, wherein the adhesive layer comprises a thermoplastic polyurethane (TPU).

5. The laminate of claim 1, wherein the adhesive layer comprises a pigment.

6. The laminate of claim 1, wherein the adhesive layer comprises a material having a gauge of 2-4 mil.

7. The laminate of claim 1, wherein the adhesive layer comprises a polyurethane film.

8. The laminate of claim 1, wherein the dye blocking layer comprises a polyurethane or polycarbonate material.

9. The laminate of claim 1, wherein the dye blocking layer comprises a polyethylene terephthalate (PET) material.

10. The laminate of claim 1, wherein the dye blocking layer comprises a blend of two or more materials.

11. The laminate of claim 1, wherein the dye blocking layer comprises a copolyester resin.

12. The laminate of claim 1, wherein the dye blocking layer comprises a white pigment.

13. The laminate of claim 1, further comprising a second adhesive layer and a top layer.

14. The laminate of claim 1, wherein the one or more layers of the laminate are extruded.

15. The laminate of claim 1, wherein the one or more layers of the laminate are laminated together.

16. A method of manufacturing a laminate comprising
a) depositing an adhesive layer; and
b) depositing a dye blocking layer on the adhesive layer.

17. The method of claim 16, wherein the adhesive layer is deposited on a release liner.

18. The method of claim 16, wherein the adhesive layer and the dye blocking layer are laminated.

19. The method of claim 16, further comprising:
a) depositing a second adhesive layer on the dye blocking layer; and
b) depositing a top layer on the second adhesive layer.

20. The method of claim 19, wherein the second adhesive layer and the top layer are laminated with the adhesive layer and the dye blocking layer.
